(19) United States
(12) Patent Application Publication
(10) Pub. No.: US 2024/0127796 A1
(43) Pub. Date: Apr. 18, 2024

(54) LEARNING APPARATUS, ESTIMATION APPARATUS, METHODS AND PROGRAMS FOR THE SAME

(71) Applicant: NIPPON TELEGRAPH AND TELEPHONE CORPORATION, Tokyo (JP)

(72) Inventors: Hiroshi SATO, Tokyo (JP); Takaaki FUKUTOMI, Tokyo (JP); Yusuke SHINOHARA, Tokyo (JP)

(73) Assignee: NIPPON TELEGRAPH AND TELEPHONE CORPORATION, Tokyo (JP)

(21) Appl. No.: 18/277,552

(22) PCT Filed: Feb. 18, 2021
(86) PCT No.: PCT/JP2021/006176

§ 371 Date: Aug. 16, 2023

(51) Int. Cl. G10L 15/06; G10L 15/16

(52) U.S. Cl. CPC G10L 15/063; G10L 15/16; G10L 2015/0635

(57) ABSTRACT

The present invention estimates intention of an utterance more accurately than the related arts. A learning device learns an estimation model on the basis of learning data including an acoustic signal for learning and a label indicating whether or not the acoustic signal has been uttered to a predetermined target. The learning device includes: a feature synchronization unit configured to obtain a post-synchronization feature by synchronizing an acoustic feature obtained from the acoustic signal for learning with a text feature corresponding to the acoustic signal; an utterance intention estimation unit configured to estimate whether or not the acoustic signal has been uttered to the predetermined target by using the post-synchronization feature; and a parameter update unit configured to update a parameter of the estimation model on the basis of the label included in the learning data and an estimation result by the utterance intention estimation unit.

### TECHNICAL FIELD

The present invention relates to a learning device that learns an estimation model for estimating whether or not an input signal is voice uttered to a predetermined target, an estimation device that performs estimation by using the learned estimation model, methods thereof, and a program.

### BACKGROUND ART

Voice input to a spoken dialogue agent is not necessarily an utterance from a user to the agent. For example, the utterance from the user may be made for another person in that place, or voice from a television reproduced in background may be input. When such the user's unintentional utterance is input to the dialogue agent, a dialogue scenario is activated in response to such input, and the agent starts talking or searches for an unintentional recognition result even though the user has not talked thereto. Such malfunctions degrade the user experience.

A voice activity detection technique is a technique for identifying whether or not an input signal is voice. The voice activity detection technique detects only a speech section (voice section) from an input signal and excludes a non-speech section (non-voice section). However, the voice activity detection technique can identify whether or not the input signal is voice, but cannot identify whether or not the input signal is voice to respond. That is, the voice activity detection technique cannot identify voice from a television, an utterance made for another speaker, or the like as voice not to respond.

As a technique for identifying voice not to respond, for example, there is a technique for determining whether or not input voice is directed to the robot from a user and identifying whether to respond to the voice, which is particularly for a spoken dialogue interface including a communication robot. For example, Non Patent Literature 1 is known.

In Non Patent Literature 1, a smart speaker is used to identify the presence or absence of intention of an utterance on the basis of an acoustic feature obtained from voice and a linguistic feature obtained from a result of recognition of the voice. The “intention of an utterance” means intention of the user uttering voice to a predetermined target, and the “presence or absence of intention of the utterance” means whether or not voice input to the predetermined target is voice that the user has intentionally uttered to the target. The predetermined target can achieve a purpose of the target more appropriately by identifying whether or not input voice is voice uttered to the target and is, for example, a dialogue system or a telephone.

### CITATION LIST

### Non Patent Literature

Non Patent Literature 1: Mallidi, S. H., Maas, R., Goehner, K., Rastrow, A., Matsoukas, S., & Hoffmeister, B., “Device-directed utterance detection”, arXiv preprint arXiv:1808.02504., 2018.

### SUMMARY OF INVENTION

### Technical Problem

In Non Patent Literature 1, the acoustic feature and the linguistic feature of the recognition result are used to perform identification, but, because the acoustic feature and the linguistic feature are separately modeled, a temporal correspondence between sequences of both the acoustic feature and the linguistic feature cannot be considered. It is impossible to perform precise modeling in consideration of to which part of the acoustic feature a part of the linguistic feature corresponds, for example, while considering that an input sound of a certain word in the recognition result sounds too friendly to talk to a machine.

An object of the present invention is to provide a learning device that learns a model capable of estimating intention of an utterance more accurately than the related arts by performing processing while grasping a correspondence between an acoustic sequence and a linguistic sequence to consider a temporal correspondence between both the sequences, an estimation device using the model, methods thereof, and a program.

### Solution to Problem

In order to solve the above problem, according to one aspect of the present invention, a learning device learns an estimation model on the basis of learning data including an acoustic signal for learning and a label indicating whether or not the acoustic signal has been uttered to a predetermined target. The learning device includes: a feature synchronization unit configured to obtain a post-synchronization feature by synchronizing an acoustic feature obtained from the acoustic signal for learning with a text feature corresponding to the acoustic signal; an utterance intention estimation unit configured to estimate whether or not the acoustic signal has been uttered to the predetermined target by using the post-synchronization feature; and a parameter update unit configured to update a parameter of the estimation model on the basis of the label included in the learning data and an estimation result by the utterance intention estimation unit.

In order to solve the above problem, according to another aspect of the present invention, an estimation device performs estimation on the basis of an estimation model learned in advance by using learning data including an acoustic signal for learning and a label indicating whether or not the acoustic signal for learning has been uttered to a predetermined target. The estimation device includes: a feature synchronization unit configured to obtain a post-synchronization feature by synchronizing an acoustic feature obtained from an acoustic signal to be estimated with a text feature corresponding to the acoustic signal to be estimated; and an utterance intention estimation unit configured to estimate whether or not the acoustic signal to be estimated has been uttered to the predetermined target by using the post-synchronization feature.

### Advantageous Effects of Invention

The present invention can estimate intention of an utterance more accurately than the related arts by performing processing while grasping a correspondence between an acoustic sequence and a linguistic sequence to consider a temporal correspondence between both the sequences.

### BRIEF DESCRIPTION OF DRAWINGS

FIG. 1 illustrates a configuration example of an estimation system according to a first embodiment.

FIG. 2 is a functional block diagram of a learning device according to the first embodiment.

FIG. 3 shows a processing flow of the learning device according to the first embodiment.

FIG. 4 is a functional block diagram of a model learning unit according to the first embodiment.

FIG. 5 shows a processing flow of the model learning unit according to the first embodiment.

FIG. 6 is a functional block diagram of an estimation device according to the first embodiment.

FIG. 7 shows a processing flow of the estimation device according to the first embodiment.

FIG. 8 is a functional block diagram of an estimation unit according to the first embodiment.

FIG. 9 shows a processing flow of the estimation unit according to the first embodiment.

FIG. 10 shows experimental results of a configuration of a second modification example and a combined configuration of a first modification example and the second modification example.

FIG. 11 is a functional block diagram of a learning device according to a second embodiment.

FIG. 12 shows a processing flow of the learning device according to the second embodiment.

FIG. 13 is a functional block diagram of a model learning unit according to the second embodiment.

FIG. 14 shows a processing flow of the model learning unit according to the second embodiment.

FIG. 15 is a functional block diagram of an estimation device according to the second embodiment.

FIG. 16 shows a processing flow of the estimation device according to the second embodiment.

FIG. 17 is a functional block diagram of an estimation unit according to the second embodiment.

FIG. 18 shows a processing flow of the estimation unit according to the second embodiment.

FIG. 19 illustrates a configuration example of a computer to which the present technique is applied.

### DESCRIPTION OF EMBODIMENTS

Hereinafter, embodiments of the present invention will be described. In the drawings used in the following description, components having the same functions or steps for performing the same processing will be denoted by the same reference signs, and description thereof will not be repeated. In the following description, processing performed for each element of a vector or matrix is applied to all elements of the vector or matrix, unless otherwise specified.

### Points of First Embodiment

(1) By performing modeling while associating an acoustic feature and a linguistic feature of a recognition result with each other in time series, more precise modeling is performed, and estimation is performed more accurately than conventional models.

(2) By recording a confidence level of labeling at the time of labeling intention of an utterance and using also the confidence level at the time of learning, a model is learned in consideration of reliability of the label. This makes it possible to reduce an influence of an uncertain label.

(3) By introducing, as a feature, a new feature focusing on a radiation direction, a direct/indirect ratio, and the like of a sound source which have not been considered so far or a new feature related to validity as an utterance to be input to a predetermined target, it is possible to grasp the presence or absence of the intention of the utterance more explicitly.

### Estimation System According to First Embodiment

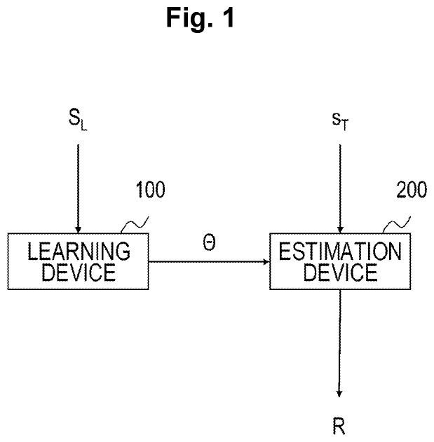

FIG. 1 illustrates a configuration example of an estimation system.

The estimation system includes a learning device 100 and an estimation device 200.

The learning device 100 uses learning data S_{L} as an input, learns an estimation model Θ_{L} on the basis of the learning data S_{L}, and outputs a learned estimation model Θ. The learning data S_{L} includes M learning acoustic signals s_{m, L}, labels r_{m, L}, and confidence levels c_{m, L}.

S_{L}=((s_{1,L},r_{1,L},c_{1,L}),(s_{2,L},r_{2,L},c_{2,L}), . . . ,(s_{M,L},r_{m,L},c_{m,L}))

The label r_{m, L} indicates whether or not the m-th learning acoustic signal s_{m, L} has been uttered to a predetermined target (the presence or absence of intention of the utterance). For example, r_{m, L}=0 means that there is no intention of the utterance, and r_{m, L}=1 means that there is intention of the utterance. The confidence level c_{m, L} indicates a confidence level of labeling by an annotator (which labels the target).

The estimation device 200 receives the learned estimation model Θ before estimation processing. The estimation device 200 receives an acoustic signal s_{T} to be estimated as an input, estimates whether or not the acoustic signal s_{T} is voice uttered to the predetermined target on the basis of the estimation model Θ, and outputs an estimation result R (an estimation value of the presence or absence of intention of the utterance).

The learning device and the estimation device are, for example, special devices configured by loading a special program onto a known or dedicated computer including a central processing unit (CPU), a main memory (random access memory (RAM)), and the like. For example, the learning device and the estimation device execute each process under the control of the central processing unit. Data input to the learning device and the estimation device or data obtained in each process is stored in, for example, the main memory. The data stored in the main memory is read to the central processing unit to be used for other processes as necessary. At least one of processing units of the learning device and the estimation device may be configured by hardware such as an integrated circuit. Each storage unit included in the learning device and the estimation device can be configured by, for example, the main memory such as a random access memory (RAM) or middleware such as a relational database or a key-value store. However, each storage unit is not necessarily provided inside the learning device or the estimation device and may be configured by an auxiliary memory including a semiconductor memory element such as a hard disk, an optical disk, or a flash memory and be provided outside the learning device or the estimation device.

First, the learning device 100 will be described.

### Learning Device 100 According to First Embodiment

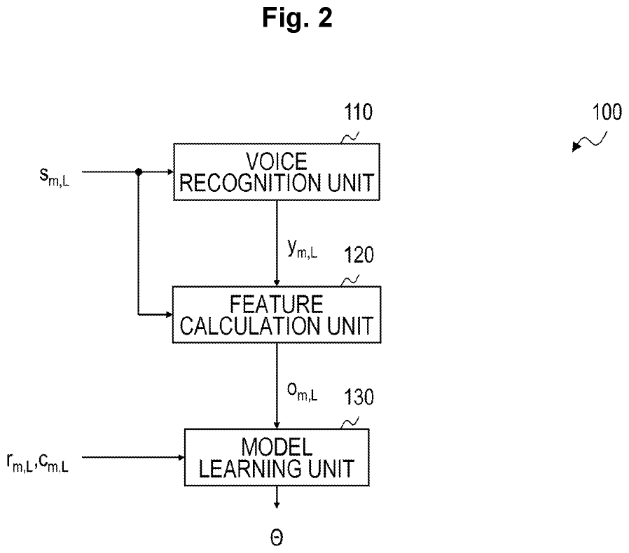

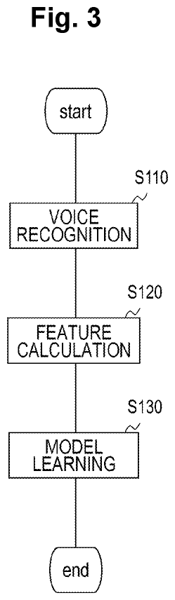

FIG. 2 is a functional block diagram of the learning device 100 according to the first embodiment, and FIG. 3 shows a processing flow thereof.

The learning device 100 includes a voice recognition unit 110, a feature calculation unit 120, and a model learning unit 130.

Each unit will be described.

<Voice Recognition Unit 110>

The voice recognition unit 110 receives the learning acoustic signal s_{m, L} as an input, executes voice recognition (S110), obtains information y_{m, L} based on the voice recognition, and outputs the information y_{m, L}. The information based on the voice recognition includes at least one of a voice recognition result and data such as reliability of the recognition result obtained when the voice recognition is executed and a calculation time taken for the voice recognition. Such linguistic information of the voice recognition result and the data such as the reliability at the time of the recognition are used to estimate the presence or absence of intention of an utterance.

<Feature Calculation Unit 120>

The feature calculation unit 120 receives the acoustic signal s_{m, L} and the information y_{m, L} based on the voice recognition as inputs, calculates a feature o_{m, L} (S120), and outputs the feature o_{m, L}. The feature o_{m, L} is used to estimate the presence or absence of intention of an utterance. For example, the feature o_{m, L} of the m-th utterance includes Nₘ features o_{m, L, n}, where n=1, 2, . . . , Nₘ, o_{m, L}=(o_{m, L, 1}, . . . , o_{m, L, N_m}). Here, the subscript A_B means A_{B}.

The feature o_{m, L} is a vector including any one or a combination of an “acoustic feature a_{m, L}”, a “text feature t_{m, L}”, and “another feature v_{m, L}”. The “acoustic feature a_{m, L}”, the “text feature t_{m, L}”, and the “another feature v_{m, L}” are vectors each including one or more elements (features).

The “acoustic feature” can be time-series data of a known acoustic feature calculated for a short-time frame, such as a mel-frequency cepstrum coefficient (MFCC) or FBANK feature, or data obtained by processing the known acoustic feature, for example, averaging the known acoustic feature in a time direction. The acoustic feature may be directly obtained from the acoustic signal s_{m, L} or may be the known acoustic feature calculated in the process of the voice recognition processing in the voice recognition unit 110. In a case where the known acoustic feature calculated in the process of the voice recognition processing in the voice recognition unit 110 is used, the acoustic signal s_{m, L} may not be received as an input.

The “text feature” is obtained by converting a word sequence or character sequence in the voice recognition result or a possible recognition result included in the information y_{m, L} based on the voice recognition into a vector sequence by a known method such as word2vec. Based on the voice recognition result or possible recognition result, it is possible to estimate whether or not the utterance is likely to be input to the predetermined target.

The “another feature” includes a feature obtained from the acoustic signal s_{m, L} and a feature obtained from the information y_{m, L} based on the voice recognition.

The “another feature” obtained from the acoustic signal s_{m, L} can include the following (i) and (ii).
(i) Information regarding a position or direction of a sound source and a distance from the sound source: it is possible to use a position or direction of the sound source calculated by a known method on the basis of an input sound or perspective information (the distance from the sound source) such as a direct/indirect ratio calculated by a known method on the basis of the input sound. In addition, time variations thereof can be used as features. For example, the distance from the sound source can be grasped on the basis of the direct/indirect ratio obtained from the voice and is useful for estimating the intention of the utterance. In a case where voices of a plurality of channels are obtained, it is possible to accurately calculate information regarding the distance or direction of the sound source and a radiation direction of the sound from the sound source. Further, it is possible to determine whether the utterance is an utterance from a person whose sound source position changes or an utterance from a fixed sound source such as a television or speaker by checking time variation of the information regarding the distance or direction of the sound source.
(ii) Information regarding an acoustic signal bandwidth or frequency characteristic: it is possible to use information such as a bandwidth or frequency characteristic of the input sound. Those pieces of information can be obtained by using the acoustic signal s_{m, L} by adopting a known technique. It is possible to grasp that the input sound is a reproduced sound of a radio, a television, or the like on the basis of the bandwidth of the voice.

The “another feature” obtained from the information y_{m, L} based on the voice recognition can include the following (iii) to (v).
(iii) Information regarding the reliability of the voice recognition result or the calculation time taken for the voice recognition: it is possible to use information such as the reliability of the voice recognition result and the calculation time taken for the voice recognition included in the information y_{m, L} based on the voice recognition. It is generally difficult to perform voice recognition on an utterance having no intention of the utterance, and thus the information such as the reliability of the voice recognition is also useful as a feature.
(iv) Information regarding validity of the utterance as a command calculated based on the voice recognition result: it is possible to use, for example, validity of the utterance as a command calculated based on the voice recognition result. The validity of the utterance as a command is, for example, a maximum value of a matching degree between each element of a list of commands included in the device and the recognition result. For example, the matching degree can be a proportion of the number of words included in the recognition result to the number of words of the command. Alternatively, the matching degree can be a distance of a vector into which both the command and the recognition result are converted by a known method such as term frequency-inverse document frequency (TF-IDF) or bag of words.
(v) Information regarding difficulty in interpretation of the input utterance obtained based on the voice recognition result: it is possible to use, for example, difficulty in interpretation of an input utterance obtained based on the voice recognition result. As the difficulty in interpretation of the utterance, it is also possible to grasp a characteristic of selecting an easy-to-understand word when a person talks to a machine, and the characteristic can be determined based on, for example, the length of the utterance represented by the number of words or the presence or absence of a demonstrative pronoun or omission or non-omission of a postpositional particle obtained from a result of parsing the recognition result.

One or a combination of those features can be used as the “another feature”.

Inputting the above features to the model learning unit 130 makes it possible to improve identification performance of the model.

<Model Learning Unit 130>

The model learning unit 130 receives the label r_{m, L}, the confidence level c_{m, L}, and the feature O_{L}=(o_{1, L}, o_{2, L}, . . . , o_{M, L}) included in the learning data S_{L} as inputs, learns the estimation model Θ_{L} by using those pieces of information (S130), and outputs the learned estimation model Θ. The estimation model is a binary classification model that estimates the presence or absence of the intention of the utterance on the basis of the feature O_{L} and can perform learning by using a known deep learning technology. As described above, the feature o_{m, L} is a vector including any one or a combination of the “acoustic feature a_{m, L}”, the “text feature t_{m, L}”, and the “another feature v_{m, L}”.

In the present embodiment, it is possible to perform learning by using the learning data including the feature o_{m, L} corresponding to an acoustic signal for one utterance, the utterance intention label r_{m, L} of the utterance, and the confidence level c_{m, L} of labeling when the intention of the utterance is labeled. In this case, an identification model of the intention of the utterance predicts not only a predicted label of the intention of the utterance but also a confidence level of labeling of data thereof by an annotator at the same time on the basis of voice of the one utterance. At the time of learning, multi-task learning is performed in which a weighted sum of a value of a loss function related to correctness or incorrectness of prediction of the intention of the utterance and a value of a loss function related to a prediction error of the confidence level of the labeling by the annotator is used as a loss function. Therefore, the model can learn the intention of the utterance while considering the confidence level of the labeling by the annotator.

The identification model of the intention of the utterance is a deep neural network (DNN) model that receives the time-series data of the acoustic feature a_{m, L}, the time-series data of the text feature t_{m, L}, the time-series data of the another feature v_{m, L}, and the another feature v_{m, L} that is not time-series, which have been calculated by the feature calculation unit 120, as inputs and outputs an estimation value of the label indicating the presence or absence of the intention of the utterance and an estimation value of the confidence level. Among those features, the time-series features can be converted into a fixed-length vector not depending on the time-series length in consideration of a relation between sequences for a long time by using a technology called convolutional neural network (CNN), long short term memory (LSTM), or self-attention. A feature having no dimension in a time-series direction, that is, a feature originally having a fixed length can be integrated, for example, by combining the feature with each time of the feature having information in the time-series direction or by converting a vector having information in the time-series direction into a fixed-length vector and combining the feature with the fixed-length vector. The model is built which outputs the intention of the utterance by the known DNN with respect to the vector in which each feature has been integrated.

In particular, because there is a temporal correspondence between the time-series data of the acoustic feature and the time-series data of the text feature, it is possible to more precisely grasp the presence or absence of the intention of the utterance by performing modeling in consideration of the temporal correspondence. In order to achieve precise grasping of the presence or absence of the intention of the utterance when those pieces of the time-series data are converted into pieces of fixed-length data, it is effective to adopt a modeling method capable of learning identification of intention of an utterance on the basis of a given utterance intention label and grasping a temporal correspondence between both pieces of the time-series data at the same time. For this, an NW structure called source target attention disclosed in Reference Literature 1 may be adopted, for example.
(Reference Literature 1) Dzmitry Bahdanau, Kyunghyun Cho, and Yoshua Bengio, “Neural machine translation by jointly learning to align and translate”, in International Conference on Learning Representations (ICLR), 2015

Specifically, time series X_{A} and X_{L}, which are obtained by processing an acoustic sequence and a linguistic sequence by DNN such as LSTM, are subjected to processing represented by

Y_{A+L}=source target attention(X_{A},X_{L},X_{L}) and

Y_{L+A}=source target attention(X_{L},X_{A},X_{A}).

Therefore, it is possible to obtain a linguistic feature sequence Y_{A+L} synchronized with an acoustic feature sequence and an acoustic feature sequence Y_{L+A} synchronized with the linguistic feature sequence. Here, source target attention (Q, K, V) indicates source target attention in which Q is a query, K is a key, and V is a value. Y_{A+L} and Y_{L+A} thus obtained are, for example, combined with or added to X_{A} and X_{L}, respectively, in a feature dimensional direction and are processed by DNN such as LSTM, thereby enabling precise modeling that grasps the temporal correspondence between both the sequences. For example, in a case where the text feature is synchronized with the acoustic feature, a frame of the text feature corresponding to the time is weighted with respect to each frame of the acoustic feature and is then acquired. The weight may be given by a neural network, or alignment information of the acoustic feature sequence and the linguistic sequence obtained by the voice recognition may be used as a weight of the attention. Alternatively, in a case where the acoustic feature is synchronized with the text feature, a frame of the acoustic feature corresponding to the time is weighted with respect to each frame of the text feature and is then acquired. The weight may be given by a neural network, or alignment information of the acoustic feature sequence and the linguistic sequence obtained by the voice recognition may be used as a weight of the attention.

A configuration of the model learning unit 130 that achieves the above processing will be described.

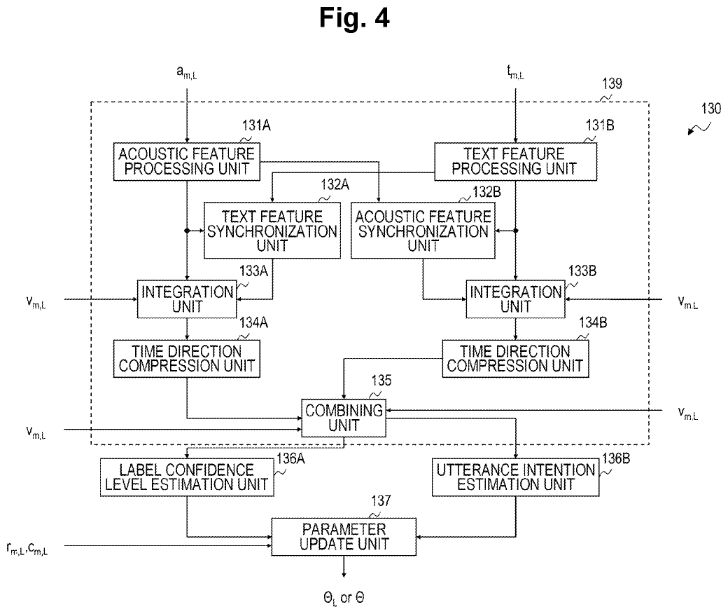

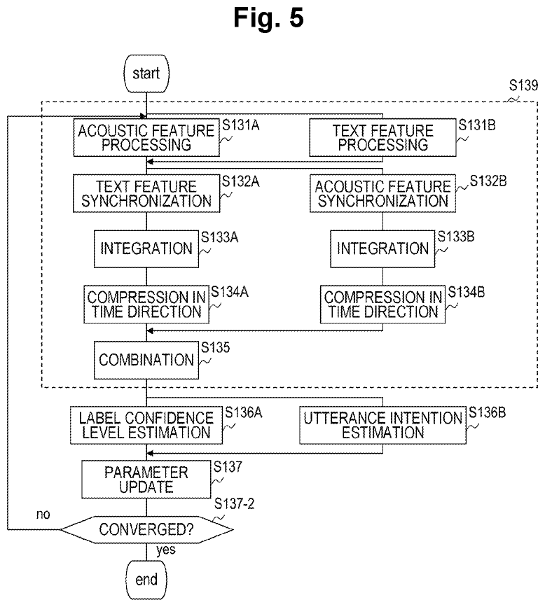

FIG. 4 is a functional block diagram of the model learning unit 130, and FIG. 5 shows a processing flow thereof.

The model learning unit 130 includes a feature synchronization unit 139, a label confidence level estimation unit 136A, an utterance intention estimation unit 136B, and a parameter update unit 137.

<Feature Synchronization Unit 139>

The feature synchronization unit 139 receives the feature O_{L}=(o_{1, L}, o_{2, L}, . . . , o_{M, L}) as an input, obtains a post-synchronization feature by synchronizing the acoustic feature a_{m, L} with the text feature t_{m, L} corresponding to the acoustic signal a_{m, L} (S139), and outputs the post-synchronization feature. For example, the feature synchronization unit 139 includes an acoustic feature processing unit 131A, a text feature processing unit 131B, a text feature synchronization unit 132A, an acoustic feature synchronization unit 132B, integration units 133A and 133B, time direction compression units 134A and 134B, and a combining unit 135 (see FIG. 4) and performs the following processing.

<Acoustic Feature Processing Unit 131A>

The acoustic feature processing unit 131A receives the acoustic feature a_{m, L} as an input, converts the acoustic feature into easily processable data in the text feature synchronization unit 132A and the integration unit 133A (S131A), and outputs the converted acoustic feature. The converted acoustic feature will also be simply referred to as the acoustic feature. The acoustic feature is converted by using, for example, DNN that performs time series modeling. Note that, in a case where the text feature synchronization unit 132A and the integration unit 133A use the unconverted acoustic feature a_{m, L} as it is, the acoustic feature processing unit 131A may not be provided.

<Text Feature Processing Unit 131B>

The text feature processing unit 131B receives the text feature t_{m, L} as an input, converts the text feature into easily processable data in the text feature synchronization unit 132B and the integration unit 133B (S131B), and outputs the converted text feature. The converted text feature will also be simply referred to as the text feature. The text feature is converted by using, for example, DNN that performs time series modeling. Note that, in a case where the text feature synchronization unit 132B and the integration unit 133B use the unconverted text feature t_{m, L} as it is, the text feature processing unit 131B may not be provided.

<Text Feature Synchronization Unit 132 A>

The text feature synchronization unit 132A receives the acoustic feature and the text feature as inputs, synchronizes the text feature with the acoustic feature (S132A), and outputs the text feature associated with each frame of the acoustic feature (hereinafter, also referred to as a post-synchronization text feature). For example, the time series X_{A} and X_{L} obtained by processing the time series of the acoustic feature and the time series of the text feature by DNN such as LSTM are subjected to processing represented by

Y_{A+L}=source target attention (X_{A}, X_{L}, X_{L}), which obtains the time series Y_{A+L} of the text feature synchronized with the time series X_{A} of the acoustic feature.

<Acoustic Feature Synchronization Unit 132 B>

The acoustic feature synchronization unit 132B receives the text feature and the acoustic feature as inputs, synchronizes the acoustic feature with the text feature (S132B), and outputs the acoustic feature associated with each frame (each character or word) of the text feature (hereinafter, also referred to as a post-synchronization acoustic feature). For example, the time series X_{A} and X_{L} obtained by processing the time series of the acoustic feature and the time series of the text feature by DNN such as LSTM are subjected to processing represented by

Y_{L+A}=source target attention (X_{L}, X_{A}, X_{A}), which obtains the time series Y_{L+A} of the acoustic feature synchronized with the time series X_{L} of the text feature.

<Integration Units 133A and 133B>

The integration unit 133A receives the post-synchronization text feature and the acoustic feature as inputs, combines the features (S133A), and outputs the combined features.

The integration unit 133B receives the post-synchronization acoustic feature and the text feature as inputs, combines the features (S133B), and outputs the combined features.

The integration unit 133A may receive the another feature v_{m, L} as an input, combine the another feature with the post-synchronization text feature and the acoustic feature, and output the combined features. Similarly, the integration unit 133B may receive the another feature v_{m, L} as an input, combine the another feature with the post-synchronization acoustic feature and the text feature, and output the combined features.

In a case where the another feature v_{m, L} has a length in the time direction, the integration unit 133A combines the “acoustic feature”, the “post-synchronization text feature”, and the “another feature v_{m, L}” in consideration of time series, and the integration unit 133B combines the “text feature”, the “post-synchronization acoustic feature”, and the “another feature v_{m, L}” in consideration of time series.

In a case where the another feature v_{m, L} does not have a length in the time direction, the integration unit 133A duplicates the another feature for the number of frames of the acoustic feature and combines the “acoustic feature a_{m, L}”, the “post-synchronization text feature”, and the “another feature” for each frame of the acoustic feature a_{m, L}, and the integration unit 133B duplicates the another feature for the number of frames (each character and word) of the text feature and combines the “text feature”, the “post-synchronization acoustic feature”, and the “another feature” for each frame of the text feature t_{m, L}.

<Time Direction Compression Units 134A and 134B>

The time direction compression units 134A and 134B receive the features output from the integration units 133A and 133B, respectively, in other words, the acoustic-based feature, the text-based feature, and the another feature having the length in the time direction as inputs, compress the features in the time direction (S134A and S134B), and output a one-dimensional fixed-length vector. Various known techniques can be used for compression processing in the time direction, and, for example, self-attention pooling may be used. The time direction aggregation units 134A and 134B may include a time-series model such as LSTM before converting the features into the one-dimensional fixed-length vector.

<Combining Unit 135>

The combining unit 135 receives the one-dimensional fixed-length vectors output from both the time direction compression units 134A and 134B as inputs, combines the vectors (S135), and outputs a post-synchronization feature that is the combined vectors.

The combining unit 135 may receive a feature having no dimension in the time-series direction among the other features v_{m, L} as an input, combine the one-dimensional fixed-length vectors output from both the time direction compression units 134A and 134B and the feature having no dimension in the time-series direction among the other features v_{m, L}, and output a post-synchronization feature that is the combined vectors.

<Label Confidence Level Estimation Unit 136A>

The label confidence level estimation unit 136A receives the post-synchronization feature as an input, estimates the confidence level at the time of giving a label on the basis of a label confidence level estimation model by using the post-synchronization feature (S136A), and outputs an estimation result (an estimation value of the label confidence level). The label confidence level estimation model receives the post-synchronization feature as an input and outputs the estimation value of the label confidence level and includes, for example, DNN.

<Utterance Intention Estimation Unit 136B>

The utterance intention estimation unit 136B receives the post-synchronization feature as an input, estimates whether or not the learning acoustic signal has been uttered to the predetermined target on the basis of the utterance intention estimation model by using the post-synchronization feature (S136B), and outputs an estimation result (an estimation value of the utterance intention label). The utterance intention estimation model receives the post-synchronization feature as an input and outputs the estimation value of the utterance intention label and includes, for example, DNN.

<Parameter Update Unit 137>

The parameter update unit 137 receives the label r_{m, L} and the confidence level c_{m, L} included in the learning data S_{L}, the estimation value of the label confidence level, and the estimation value of the utterance intention label as inputs and updates parameters of the estimation model on the basis of those values (S137). The estimation model receives the acoustic feature obtained from the acoustic signal and the text feature corresponding to the acoustic signal as inputs and outputs the estimation value of the utterance intention label of the acoustic signal. For example, the parameter update unit 137 updates the parameters used in the acoustic feature processing unit 131A, the text feature processing unit 131B, the text feature synchronization unit 132A, the acoustic feature synchronization unit 132B, the time direction compression units 134A and 134B, the label confidence level estimation unit 136A, and the utterance intention estimation unit 136B so that the label r_{m, L} matches the estimation value of the utterance intention label and the confidence level c_{m, L} matches the estimation value of the label confidence level.

In a case where a convergence condition is not satisfied (no in S137-2), the parameter update unit 137 outputs the updated parameters to the respective units and repeats the above processing in S131A to S136B by using the updated parameters.

In a case where the convergence condition is satisfied (yes in S137-2), the parameter update unit 137 outputs the updated parameters as the estimation model S including the learned parameters.

The convergence condition is a condition for determining whether or not update of the parameters has converged. The convergence condition is, for example, that the number of times of update exceeds a predetermined number of times or that a difference between unupdated parameters and updated parameters is less than a predetermined threshold.

Next, the estimation device 200 will be described.

<Estimation Device 200 According to First Embodiment>

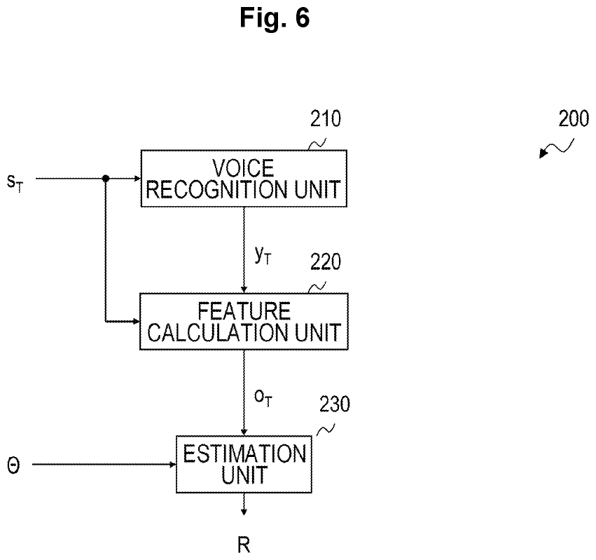

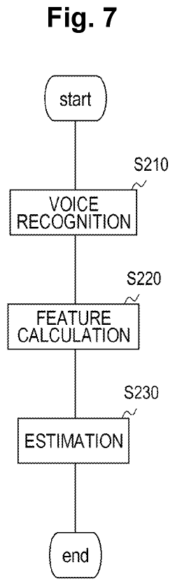

FIG. 6 is a functional block diagram of the estimation device 200 according to the first embodiment, and FIG. 7 shows a processing flow thereof.

The learning device 100 includes a voice recognition unit 210, a feature calculation unit 220, and an estimation unit 230.

Each unit will be described.

<Voice Recognition Unit 210>

The voice recognition unit 210 receives an acoustic signal s_{T} to be estimated as an input, executes voice recognition (S210), obtains information y_{T} based on the voice recognition, and outputs the information y_{T}. For example, the voice recognition unit 210 performs voice recognition processing similar to that of the voice recognition unit 110.

<Feature Calculation Unit 220>

The feature calculation unit 220 receives the acoustic signal s_{T} and the information y_{T} based on the voice recognition, calculates a feature o_{T} (S220), and outputs the feature o_{T}. For example, the feature calculation unit 220 performs feature calculation processing similar to that of the feature calculation unit 120.

<Estimation Unit 230>

The estimation unit 230 receives the learned estimation model Θ before the estimation processing.

The estimation unit 230 receives the feature o_{T} as an input, estimates the presence or absence of intention of an utterance by using the learned estimation model Θ (S230), and outputs an estimation result R. The estimation unit gives the feature o_{T} to the learned estimation model Θ as an input and obtains the estimation result R of the presence or absence of the intention of the utterance as an output. The estimation result R is, for example, a binary label indicating the presence or absence of the intention of the utterance.

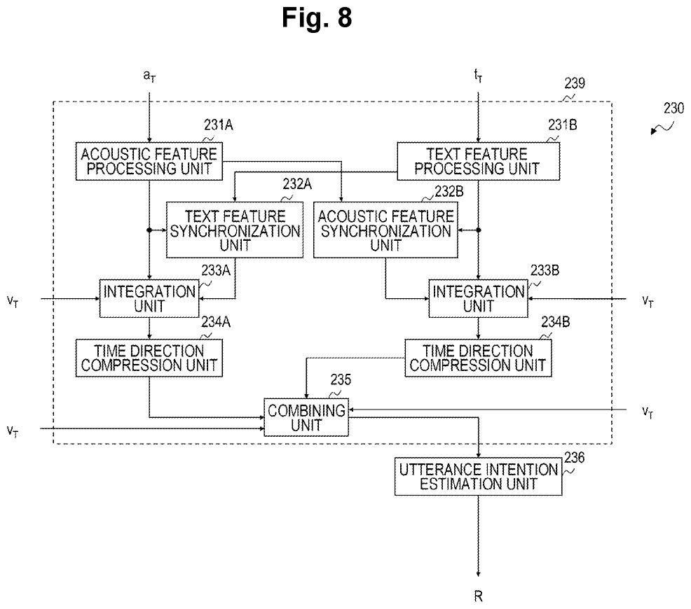

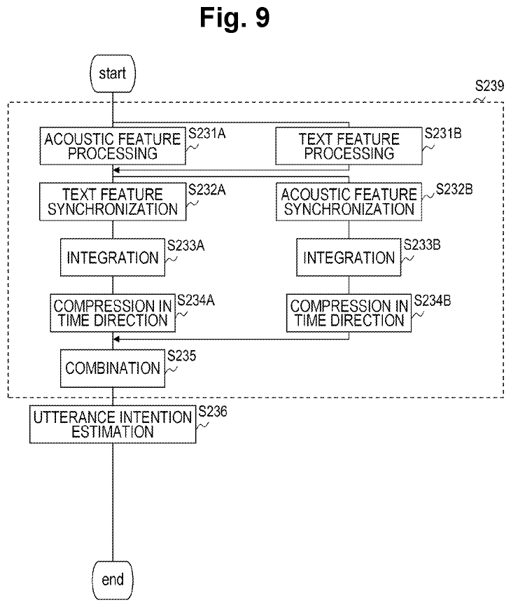

FIG. 8 is a functional block diagram of the estimation unit 230, and FIG. 9 shows a processing flow thereof.

The estimation unit 230 includes a feature synchronization unit 239 and an utterance intention estimation unit 236. The feature synchronization unit 239 includes an acoustic feature processing unit 231A, a text feature processing unit 231B, a text feature synchronization unit 232A, an acoustic feature synchronization unit 232B, integration units 233A and 233B, time direction compression units 234A and 234B, and a combining unit 235.

The feature synchronization unit 239 and the utterance intention estimation unit 236 perform processing in S239 and S236 similar to that of the feature synchronization unit 139 and the utterance intention estimation unit 136, respectively. Therefore, the acoustic feature processing unit 231A, the text feature processing unit 231B, the text feature synchronization unit 232A, the acoustic feature synchronization unit 232B, the integration units 233A and 233B, the time direction compression units 234A and 234B, and the combining unit 235 in the feature synchronization unit 239 perform processing in S231S to S235 similar to that of the acoustic feature processing unit 131A, the text feature processing unit 131B, the text feature synchronization unit 132A, the acoustic feature synchronization unit 132B, the integration units 133A and 133B, the time direction compression units 134A and 134B, and the combining unit 135 in the feature synchronization unit 139, respectively. However, each process is performed on a value based on the feature o_{T}, instead of the value based on the feature o_{m, L}.

### Effects

With this configuration, it is possible to estimate intention of an utterance more accurately than the related arts by performing processing while grasping a correspondence between an acoustic sequence and a linguistic sequence to consider a temporal correspondence between both the sequences.

In Non Patent Literature 1, a manually annotated correct answer label of intention of an utterance is required to learn a model. However, in a case where the annotation is performed on a voice log of the spoken dialogue interface, it is difficult even for a human to identify intention of an utterance of some data, and thus an incorrect label may be given. If learning is performed by using the incorrect label, identification accuracy decreases, which is problematic. A general method of dealing with inaccuracy of the label is to perform labeling by a plurality of annotators and decide a label by majority vote. However, this requires costs in proportional to the number of annotators, and, in addition, difficult data that any of the annotators cannot determine cannot be dealt with.

According to the present embodiment, it is possible to learn a model while recognizing that it is difficult to correctly answer data whose annotation is difficult even for a human.

The accurate estimation of the intention of the utterance contributes to prevention of such malfunctions that degrade the user experience.

Further, as a task other than voice recognition, it is possible to accurately present only voice of an interacting user to the other party in telecommunication by telephone or the like by using the estimation system according to the present embodiment.

For example, the estimation processing in S230 of the present embodiment may be performed as subsequent processing of the voice recognition device and be passed to an application together with a recognition hypothesis.

### First Modification Example: Configuration Without Using Confidence Level

Differences from the first embodiment will be mainly described.

In the first embodiment, the confidence level c_{m, L} of labeling by the annotator (which labels the target) is used for learning, but the confidence level c_{m, L} is not used in the present modification example.

In this case, the learning data S_{L} includes M learning acoustic signals s_{m, L} and labels r_{m, L}.

S_{L}=((s_{1,L},r_{1,L}),(s_{2,L},r_{2,L}), . . . ,(s_{M,L},r_{M,L}))

The model learning unit 130 does not include the label confidence level estimation unit 136A.

The parameter update unit 137 receives the label r_{m, L} included in the learning data S_{L} and the estimation value of the utterance intention label as inputs and updates parameters of the estimation model on the basis of those values (S137). For example, the parameter update unit 137 updates the parameters used in the acoustic feature processing unit 131A, the text feature processing unit 131B, the text feature synchronization unit 132A, the acoustic feature synchronization unit 132B, the time direction compression units 134A and 134B, and the utterance intention estimation unit 136B so that the label r_{m, L} matches the estimation value of the utterance intention label (S137).

### Second Modification Example: Configuration Without Using Another Feature

Differences from the first embodiment will be mainly described.

In the first embodiment, the another feature is used for learning and estimation, but the another feature is not used in the present modification example.

The features calculated by the feature calculation units 120 and 220 do not include the another feature. Therefore, the integration units 133A, 133B, 233A, and 233B or the integration units 135 and 235 do not perform processing of integrating or combining the other features.

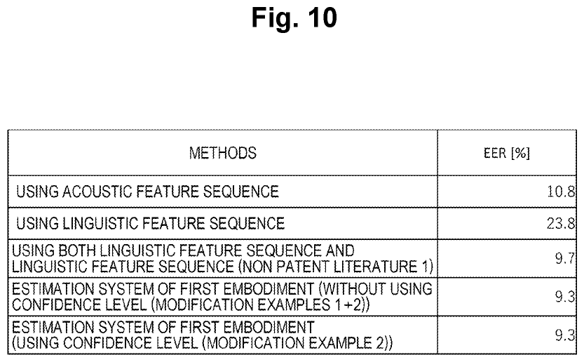

FIG. 10 shows experimental results of the configuration of the second modification example and a combined configuration of the first modification example and the second modification example. Any of the configurations can estimate intention of an utterance more accurately than the related arts.

### Third Modification Example

Differences from the first embodiment will be mainly described.

The label confidence level estimation unit 136A and the utterance intention estimation unit 136B do not necessarily need to receive the combined vectors as an input and may receive at least one of the vector output from the time direction compression unit 134A and the vector output from the time direction compression unit 134B as an input to obtain the estimation values of the label confidence level and the utterance intention label. In this case, the post-synchronization feature includes at least one of the vector output from the time direction compression unit 134A and the vector output from the time direction compression unit 134B. In a case where the vector output from the time direction compression unit 134A is used as the post-synchronization feature, the model learning unit 130 may not include the acoustic feature synchronization unit 132B, the integration unit 133B, the time direction compression unit 134B, and the combining unit 135, and, in a case where the vector output from the time direction compression unit 134B is used as the post-synchronization feature, the model learning unit 130 may not include the acoustic feature synchronization unit 132A, the integration unit 133A, the time direction compression unit 134A, and the combining unit 135. In this case, the label confidence level estimation model receives the post-synchronization feature including at least one of the vector output from the time direction compression unit 134A and the vector output from the time direction compression unit 134B as an input and outputs the estimation value of the label confidence level. Similarly, the utterance intention estimation model receives the post-synchronization feature including at least one of the vector output from the time direction compression unit 134A and the vector output from the time direction compression unit 134B as an input and outputs the estimation value of the utterance intention label.

Similarly, the utterance intention estimation unit 236 does not necessarily need to receive the combined vectors as an input and may receive the post-synchronization feature including at least one of the vector output from the time direction compression unit 234A and the vector output from the time direction compression unit 234B as an input to obtain the estimation value of the utterance intention label. In a case where the vector output from the time direction compression unit 234A is used as the post-synchronization feature, the estimation unit 230 may not include the acoustic feature synchronization unit 232B, the integration unit 233B, the time direction compression unit 234B, and the combining unit 235, and, in a case where the vector output from the time direction compression unit 234B is used as the post-synchronization feature, the estimation unit 230 may not include the acoustic feature synchronization unit 232A, the integration unit 233A, the time direction compression unit 234A, and the combining unit 235.

With this configuration, processing is performed while synchronizing one of the acoustic feature and the text feature with the other and grasping the correspondence between the acoustic sequence and the linguistic sequence. This makes it possible to obtain an effect similar to that of the first embodiment. Estimation accuracy is higher by using the vectors output from the time direction compression units 134A and 234A, that is, by using the fixed-length vectors obtained on the basis of the acoustic feature and the post-synchronization text feature obtained by synchronizing the text feature with the acoustic feature.

### Fourth Modification Example

Differences from the first embodiment will be mainly described.

In the present embodiment, the learning acoustic signal is included in the learning data. However, S110 and S120 may be performed in an external device, and the corresponding acoustic feature and text feature may be included in the learning data, instead of the learning acoustic signal. The acoustic feature processing 131A and the text feature processing 131B may be performed in the learning device 100 or in the external device as necessary. The same applies to the estimation device 200, and S210 and S220 may be performed in an external device, and the corresponding acoustic feature and text feature may be input, instead of an acoustic signal to be estimated.

### Second Embodiment

Differences from the first embodiment will be mainly described.

### Learning Device 100 According to Second Embodiment

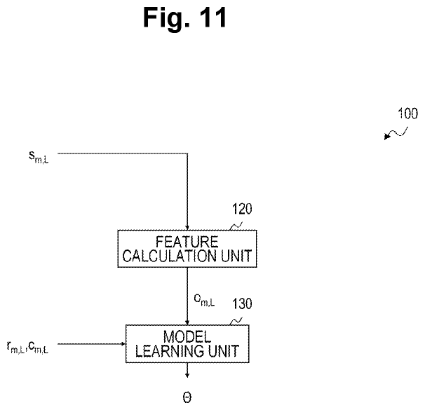

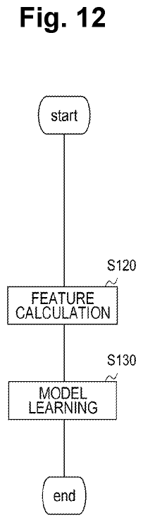

FIG. 11 is a functional block diagram of the learning device 100 according to a second embodiment, and FIG. 12 shows a processing flow thereof.

The learning device 100 includes a feature calculation unit 120 and a model learning unit 130. That is, the learning device 100 according to the second embodiment does not include the voice recognition unit 110.

<Feature Calculation Unit 120>

The feature calculation unit 120 receives the acoustic signal s_{m, L} as an input, calculates the feature o_{m, L} (S120), and outputs the feature o_{m, L}. The feature o_{m, L} is used to estimate the presence or absence of intention of an utterance.

The feature o_{m, L} is a vector including any one or a combination of the “acoustic feature a_{m, L}” and the “another feature v_{m, L}”. The “acoustic feature a_{m, L}” and the “another feature v_{m, L}” are vectors each including one or more elements (features).

The “acoustic feature” is as described above in the first embodiment.

The “another feature” includes only the feature obtained from the acoustic signal s_{m, L} described in the first embodiment. In the present embodiment, the another feature is a fixed-length vector.

<Model Learning Unit 130>

The model learning unit 130 receives the label r_{m, L}, the confidence level c_{m, L}, and the feature O_{L}=(o_{1, L}, o_{2, L}, . . . , o_{M, L}) included in the learning data S_{L} as inputs, learns the estimation model Θ_{L} by using those pieces of information (S130), and outputs the learned estimation model Θ.

In the second embodiment, a relationship between the acoustic feature and the output label can be learned by using a technology such as a known LSTM or LSTM with a self-attention mechanism. Regarding a feature holding time-series information, such as MFCC or FBANK feature, a model is learned by inputting the feature to a model such as the known LSTM or LSTM with the self-attention mechanism to obtain a fixed-length vector, inputting the output vector and a vector combined with a feature holding no time-series information to a model such as DNN, and outputting 0 to 1 indicating whether or not the utterance has been made to the target.

A configuration of the model learning unit 130 that achieves the above processing will be described.

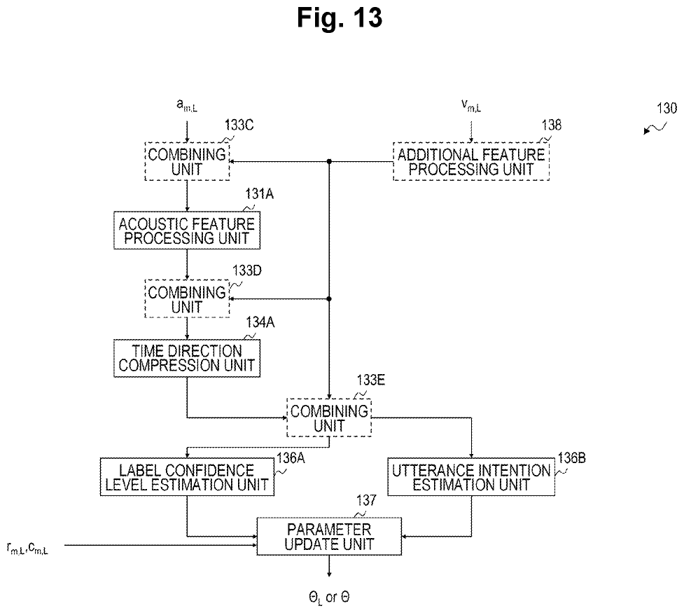

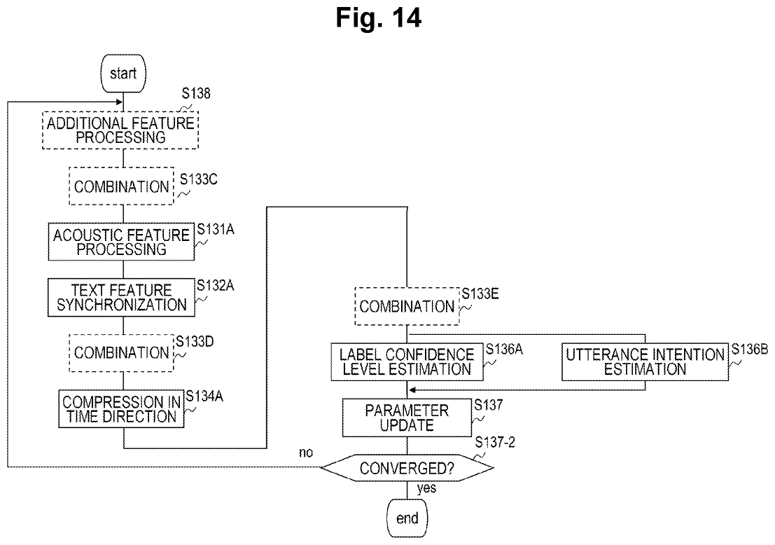

FIG. 13 is a functional block diagram of the model learning unit 130, and FIG. 14 shows a processing flow thereof.

The model learning unit 130 includes the acoustic feature processing unit 131A, the time direction compression unit 134A, the label confidence level estimation unit 136A, the utterance intention estimation unit 136B, and the parameter update unit 137.

The model learning unit 130 includes at least one of the combining units 133C, 133D, and 133E. The model learning unit 130 further includes an additional feature processing unit 138 as necessary.

<Additional Feature Processing Unit 138>

The additional feature processing unit 138 receives the another feature v_{m, L} as an input, converts the another feature into easily processable data in the combining units 133C, 133D, and 133E (S138), and outputs the converted another feature. The converted another feature will also be simply referred to as the another feature. The another feature is converted by using, for example, DNN that performs time series modeling. However, in a case where the combining units 133C, 133D, and 133E use the unconverted another feature v_{m, L} as it is, the additional feature processing unit 138 may not be provided.

<Combining Unit 133C>

The combining unit 133C receives the acoustic feature a_{m, L} and the another feature as inputs, duplicates the another feature for the number of frames of the acoustic feature a_{m, L}, combines the another feature with each frame of the acoustic feature a_{m, L} (S133C), and outputs the combined features. The acoustic feature a_{m, L} combined with the another feature will also be simply referred to as the acoustic feature a_{m, L}.

<Acoustic Feature Processing Unit 131A>

The acoustic feature processing unit 131A receives the acoustic feature a_{m, L} as an input, converts the acoustic feature into easily processable data in the combining unit 133D or the time direction compression unit 134A (S131A), and outputs the converted acoustic feature. The converted acoustic feature will also be simply referred to as the acoustic feature. The acoustic feature is converted by using, for example, DNN that performs time series modeling. Note that, in a case where the combining unit 133D or the time direction compression unit 134A uses the unconverted acoustic feature a_{m, L} as it is, the acoustic feature processing unit 131A may not be provided.

<Combining Unit 133D>

The combining unit 133D receives the acoustic feature a_{m, L} and the another feature as inputs, duplicates the another feature for the number of frames of the acoustic feature a_{m, L}, combines the another feature with each frame of the acoustic feature a_{m, L} (S133D), and outputs the combined features. The acoustic feature a_{m, L} combined with the another feature will also be simply referred to as the acoustic feature a_{m, L}.

<Time Direction Compression Unit 134A>

The time direction compression unit 134A compresses, in the time direction, the feature output from the acoustic feature processing unit 131A or the combining unit 133D, in other words, the acoustic-based feature having the length in the time direction (S134A) to obtain a one-dimensional fixed-length vector and outputs the one-dimensional fixed-length vector.

<Combining Unit 133E>

The combining unit 135 combines the one-dimensional fixed-length vector output from the time direction compression unit 134A with the another feature v_{m, L} (S133E) and outputs the combined vectors.

Processing in the label confidence level estimation unit 136A and the utterance intention estimation unit 136B is similar to that in the first embodiment.

<Parameter Update Unit 137>

The parameter update unit 137 receives the label r_{m, L} and the confidence level c_{m, L} included in the learning data S_{L}, the estimation value of the label confidence level, and the estimation value of the utterance intention label as inputs and updates parameters of the estimation model on the basis of those values (S137). For example, the parameter update unit 137 updates the parameters used in the acoustic feature processing unit 131A, the time direction compression unit 134A, the label confidence level estimation unit 136A, and the utterance intention estimation unit 136B so that the label r_{m, L} matches the estimation value of the utterance intention label and the confidence level c_{m, L} matches the estimation value of the label confidence level (S137).

In a case where a convergence condition is not satisfied (no in S137-2), the parameter update unit 137 outputs the updated parameters to the respective units and repeats the above processing in S138 to S136B by using the updated parameters.

In a case where the convergence condition is satisfied (yes in S137-2), the parameter update unit 137 outputs the updated parameters as the learned parameters.

### Estimation Device 200 According to Second Embodiment

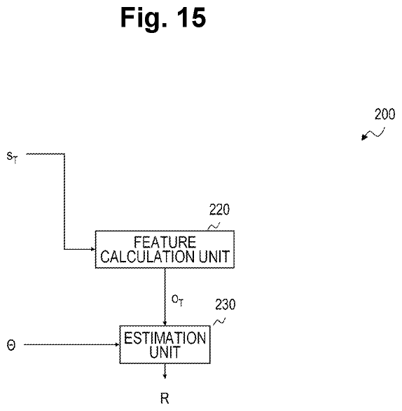

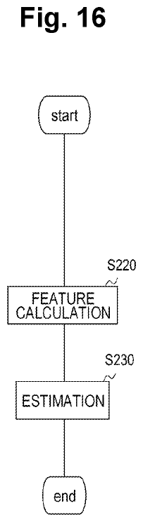

FIG. 15 is a functional block diagram of the estimation device 200 according to the second embodiment, and FIG. 16 shows a processing flow thereof.

The learning device 100 includes the feature calculation unit 220 and the estimation unit 230.

Each unit will be described.

<Feature Calculation Unit 220>

The feature calculation unit 220 receives the acoustic signal s_{T} as an input, calculates the feature o_{T}(S220), and outputs the feature o_{T}. For example, the feature calculation unit 220 performs feature calculation processing similar to that of the feature calculation unit 120 according to the second embodiment.

<Estimation Unit 230>

The estimation unit 230 receives the learned estimation model S before the estimation processing.

The estimation unit 230 receives the feature o_{T} as an input, estimates the presence or absence of intention of an utterance by using the learned model (S230), and outputs the estimation result R. The estimation unit gives the feature o_{T} to the learned model as an input and obtains the estimation result R of the presence or absence of the intention of the utterance as an output. The estimation result R is, for example, a binary label indicating the presence or absence of the intention of the utterance.

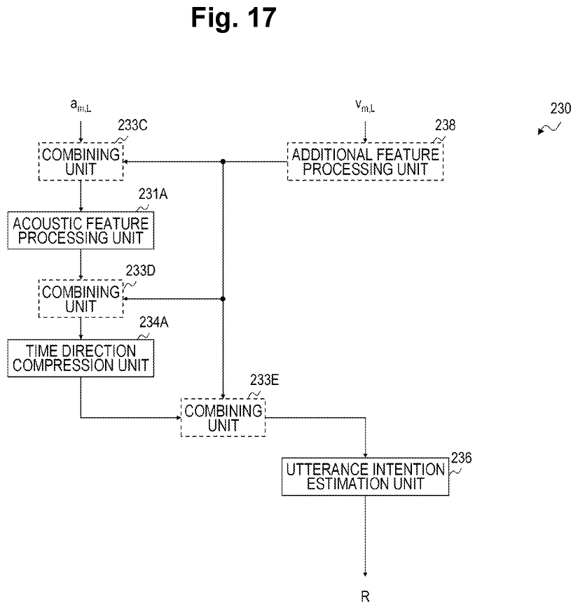

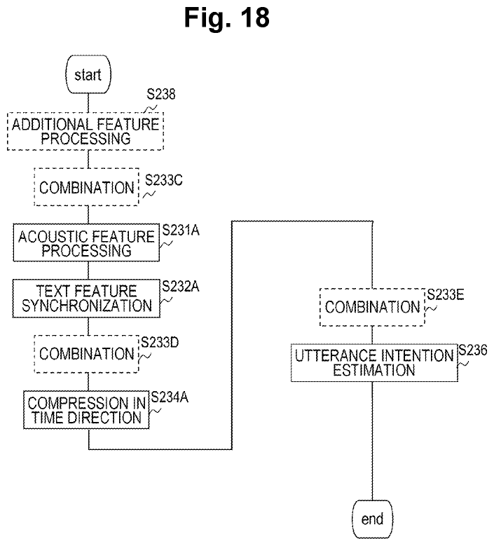

FIG. 17 is a functional block diagram of the estimation unit 230, and FIG. 18 shows a processing flow thereof.

The estimation unit 230 includes the acoustic feature processing unit 231A, the time direction compression unit 234A, and the utterance intention estimation unit 236.

The estimation unit further includes combining units 233C, 233D, and 233E and an additional feature processing unit 238 corresponding to the combining units 133C, 133D, and 133E and the additional feature processing unit 138 of the model learning unit 130.

The acoustic feature processing unit 231A, the time direction compression unit 234A, the utterance intention estimation unit 236, the combining units 233C, 233D, and 233E, and the additional feature processing unit 238 perform processing in S238 to S236 similar to that of the acoustic feature processing unit 131A, the time direction compression unit 134A, the utterance intention estimation unit 136B, the combining units 133C, 133D, and 133E, and the additional feature processing unit 138 according to the second embodiment, respectively. However, each process is performed on a value based on the feature o_{T}, instead of the value based on the feature o_{m, L}.

### Effects

With this configuration, it is possible to grasp the presence or absence of intention of an utterance more explicitly by introducing a new feature focusing on a radiation direction, a direct/indirect ratio, and the like of a sound source which have not been considered so far. This configuration may be used as a post filter of voice recognition in a case where, for example, intention of a speaker is to be grasped without waiting for output of hypothesis.

### OTHER MODIFICATION EXAMPLES

The present invention is not limited to the above embodiments or modification examples. For example, the above various kinds of processing may be executed not only in time series in accordance with the description but also in parallel or individually in accordance with processing ability of the devices that execute the processing or as necessary. Further, modifications can be appropriately made within the gist of the present invention.

<Program and Recording Medium>

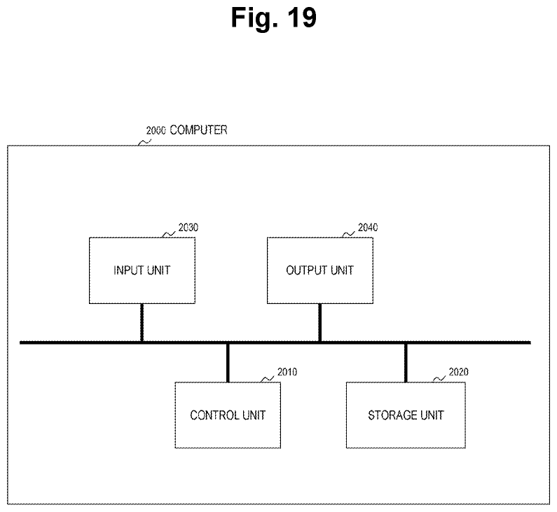

The above various kinds of processing can be implemented by loading a program for executing each step of the above method into a storage unit 2020 of a computer illustrated in FIG. 19 and operating a control unit 2010, an input unit 2030, an output unit 2040, and the like.

The program describing the content of the processing can be recorded in a computer-readable recording medium. The computer-readable recording medium may be, for example, any recording medium such as a magnetic recording device, an optical disk, a magneto-optical recording medium, or a semiconductor memory.

The program is distributed by, for example, selling, transferring, or lending a portable recording medium such as a DVD or CD-ROM on which the program is recorded. The program may be stored in a storage device of a server computer and be distributed by transferring the program from the server computer to another computer via a network.

For example, the computer that executes such a program first temporarily stores the program recorded in the portable recording medium or the program transferred from the server computer in the storage device of the own computer. Then, when executing processing, the computer reads the program stored in the recording medium of the own computer and executes processing according to the read program. As another mode of executing the program, the computer may directly read the program from the portable recording medium and execute processing according to the program, or, every time when the program is transferred from the server computer to the computer, the computer may sequentially execute processing according to the received program. Alternatively, the above processing may be executed by a so-called application service provider (ASP) service that implements a processing function only by issuing an instruction to execute the program and acquiring the result, without transferring the program from the server computer to the computer. The program in the present embodiments includes information used for processing by the computer and equivalent to the program (e.g. data that is not a direct command to the computer but has a property of defining processing of the computer).

Although the present device is configured by executing a predetermined program on the computer in the present embodiments, at least part of content of the processing may be implemented by hardware.

The program that is executed by the CPU reading software (program) in the above embodiments may be executed by various processors other than the CPU. Examples of the processors in this case include a programmable logic device (PLD) whose circuit configuration can be changed after the manufacturing, such as a graphics processing unit (GPU) or a field-programmable gate array (FPGA), and a dedicated electric circuit that is a processor having a circuit configuration exclusively designed for executing specific processing, such as an application specific integrated circuit (ASIC). Further, the program may be executed by one of the various processors or may be executed by a combination of two or more processors of the same type or different types (e.g. a combination of a plurality of FPGAs or a combination of the CPU and the FPGA). More specifically, a hardware structure of the various processors is an electric circuit in which circuit elements such as semiconductor elements are combined.

Regarding the above embodiments, the following supplementary notes are further disclosed.

(Supplementary Note 1)

A learning device that learns an estimation model on the basis of learning data including an acoustic signal for learning and a label indicating whether or not the acoustic signal has been uttered to a predetermined target, the learning device including:

a memory; and

at least one processor connected to the memory, wherein

the processor

obtains a post-synchronization feature by synchronizing an acoustic feature obtained from the acoustic signal for learning with a text feature corresponding to the acoustic signal,

estimates whether or not the acoustic signal has been uttered to the predetermined target by using the post-synchronization feature, and

updates a parameter of the estimation model on the basis of the label included in the learning data and an estimation result by the utterance intention estimation unit.

(Supplementary Note 2)

An estimation device that performs estimation on the basis of an estimation model learned in advance by using learning data including an acoustic signal for learning and a label indicating whether or not the acoustic signal for learning has been uttered to a predetermined target, the estimation device including:

a memory; and

at least one processor connected to the memory, wherein

the processor

obtains a post-synchronization feature by synchronizing an acoustic feature obtained from an acoustic signal to be estimated with a text feature corresponding to the acoustic signal to be estimated, and

estimates whether or not the acoustic signal to be estimated has been uttered to the predetermined target by using the post-synchronization feature.

1. A device comprising a processor configured to execute operations comprising:
receiving learning data, wherein the learning data includes an acoustic signal and a label, and the label indicates whether the acoustic signal has been uttered to a predetermined target;
obtaining, based on the acoustic signal, an acoustic feature;
determining a post-synchronization feature by synchronizing the acoustic feature with a text feature corresponding to the acoustic signal;
estimating whether the acoustic signal has been uttered to a predetermined target by using the post-synchronization feature; and
updating, based on the label in the learning data and an estimation result, a parameter of an estimation model.

2. The device according to claim 1, wherein the post-synchronization feature includes at least one of:
a fixed-length vector obtained based on the acoustic feature and a post-synchronization text feature obtained by synchronizing the text feature with the acoustic feature, or
a fixed-length vector obtained based on the text feature and a post-synchronization acoustic feature obtained by synchronizing the acoustic feature with the text feature.

3. The device according to claim 1, wherein:
the learning data includes the acoustic signal for learning, the label indicating whether or not the acoustic signal for learning has been uttered to the predetermined target, and a confidence level at the time of giving the label, and
the processor further configured to execute operations comprising:
estimating the confidence level at the time of giving the label by using the post-synchronization feature; and
updating the parameter of the estimation model on the basis of the label, the estimated whether the acoustic signal has been uttered to the predetermined target, the confidence level included in the learning data, and the estimated confidence level.

4. The device according to claim 1, wherein:
another feature includes at least one of:
(i) information regarding a position or direction of a sound source and a distance from the sound source,
(ii) information regarding an acoustic signal bandwidth or a frequency characteristic,
(iii) information regarding reliability of a voice recognition result or a calculation time taken for voice recognition,
(iv) information regarding validity of an utterance as a command calculated based on the voice recognition result, or
(v) information regarding difficulty in interpretation of an input utterance obtained based on the voice recognition result; and
the estimation model is learned by using the label included in the learning data, the acoustic feature, the text feature, and said another feature.

5. A device comprising a processor configured to executed operations comprising:
receiving learning data, wherein the learning data includes an acoustic signal and a label, and the label indicates whether the acoustic signal has been uttered to a predetermined target;
obtaining, based on the acoustic signal, an acoustic feature;
determining a post-synchronization feature by synchronizing the acoustic feature with a text feature corresponding to the acoustic signal to be estimated; and
estimating, based on an estimation model, whether the acoustic signal to be estimated has been uttered to a predetermined target by using the post-synchronization feature; and
updating, based on the label in the learning data and an estimation result, a parameter of the estimation model.

6. A computer implemented method for learning an estimation model, the method comprising:
receiving learning data, wherein the learning data includes an acoustic signal and a label, and the label indicates whether the acoustic signal has been uttered to a predetermined target;
obtaining, based on the acoustic signal, an acoustic feature;
determining a post-synchronization feature by synchronizing the acoustic feature with a text feature corresponding to the acoustic signal;
estimating whether the acoustic signal has been uttered to a predetermined target by using the post-synchronization feature; and
updating, based on the label in the learning data and an estimation result, a parameter of the estimation model.

7-8. (canceled)

9. The device according to claim 2, wherein:
the learning data includes the acoustic signal for learning, the label indicating whether or not the acoustic signal for learning has been uttered to the predetermined target, and a confidence level at the time of giving the label,
the processor further configured to execute operations comprising:
estimating the confidence level at the time of giving the label by using the post-synchronization feature; and
updating the parameter of the estimation model on the basis of the label, the estimated whether the acoustic signal has been uttered to the predetermined target, the confidence level included in the learning data, and the estimated confidence level.

10. The device according to claim 2, wherein:
another feature includes at least one of:
(i) information regarding a position or direction of a sound source and a distance from the sound source,
(ii) information regarding an acoustic signal bandwidth or a frequency characteristic,
(iii) information regarding reliability of a voice recognition result or a calculation time taken for voice recognition,
(iv) information regarding validity of an utterance as a command calculated based on the voice recognition result, or
(v) information regarding difficulty in interpretation of an input utterance obtained based on the voice recognition result; and
the estimation model is learned by using the label included in the learning data, the acoustic feature, the text feature, and said another feature.

11. The device according to claim 3, wherein:
another feature includes at least one of:
(i) information regarding a position or direction of a sound source and a distance from the sound source,
(ii) information regarding an acoustic signal bandwidth or a frequency characteristic,
(iii) information regarding reliability of a voice recognition result or a calculation time taken for voice recognition,
(iv) information regarding validity of an utterance as a command calculated based on the voice recognition result, or
(v) information regarding difficulty in interpretation of an input utterance obtained based on the voice recognition result; and
the estimation model is learned by using the label included in the learning data, the acoustic feature, the text feature, and said another feature.

12. The device according to claim 5, wherein
the post-synchronization feature includes at least one of:
a fixed-length vector obtained based on the acoustic feature and a post-synchronization text feature obtained by synchronizing the text feature with the acoustic feature, or
a fixed-length vector obtained based on the text feature and a post-synchronization acoustic feature obtained by synchronizing the acoustic feature with the text feature.

13. The device according to claim 5, wherein
the learning data includes the acoustic signal for learning, the label indicating whether or not the acoustic signal for learning has been uttered to the predetermined target, and a confidence level at the time of giving the label,
the processor further configured to execute operations comprising:
estimating the confidence level at the time of giving the label by using the post-synchronization feature; and
updating the parameter of the estimation model on the basis of the label, the estimated whether the acoustic signal has been uttered to the predetermined target, the confidence level included in the learning data, and the estimated confidence level.

14. The device according to claim 5, wherein:
another feature includes at least one of:
(i) information regarding a position or direction of a sound source and a distance from the sound source,
(ii) information regarding an acoustic signal bandwidth or a frequency characteristic,
(iii) information regarding reliability of a voice recognition result or a calculation time taken for voice recognition,
(iv) information regarding validity of an utterance as a command calculated based on the voice recognition result, or
(v) information regarding difficulty in interpretation of an input utterance obtained based on the voice recognition result; and
the estimation model is learned by using the label included in the learning data, the acoustic feature, the text feature, and said another feature.

15. The device according to claim 12,
the learning data includes the acoustic signal for learning, the label indicating whether or not the acoustic signal for learning has been uttered to the predetermined target, and a confidence level at the time of giving the label,
the processor further configured to execute operations comprising:
estimating the confidence level at the time of giving the label by using the post-synchronization feature; and
updating the parameter of the estimation model on the basis of the label, the estimated whether the acoustic signal has been uttered to the predetermined target, the confidence level included in the learning data, and the estimated confidence level.

16. The device according to claim 12, wherein:
another feature includes at least one of:
(i) information regarding a position or direction of a sound source and a distance from the sound source,
(ii) information regarding an acoustic signal bandwidth or a frequency characteristic,
(iii) information regarding reliability of a voice recognition result or a calculation time taken for voice recognition,
(iv) information regarding validity of an utterance as a command calculated based on the voice recognition result, or
(v) information regarding difficulty in interpretation of an input utterance obtained based on the voice recognition result; and
the estimation model is learned by using the label included in the learning data, the acoustic feature, the text feature, and said another feature.

17. The computer implemented method according to claim 6, wherein
the post-synchronization feature includes at least one of:
a fixed-length vector obtained based on the acoustic feature and a post-synchronization text feature obtained by synchronizing the text feature with the acoustic feature, or
a fixed-length vector obtained based on the text feature and a post-synchronization acoustic feature obtained by synchronizing the acoustic feature with the text feature.

18. The computer implemented method according to claim 6, wherein
the learning data includes the acoustic signal for learning, the label indicating whether or not the acoustic signal for learning has been uttered to the predetermined target, and a confidence level at the time of giving the label,
the processor further configured to execute operations comprising:
estimating the confidence level at the time of giving the label by using the post-synchronization feature; and
updating the parameter of the estimation model on the basis of the label, the estimated whether the acoustic signal has been uttered to the predetermined target, the confidence level included in the learning data, and the estimated confidence level.

19. The computer implemented method according to claim 6, wherein
another feature includes at least one of:
(i) information regarding a position or direction of a sound source and a distance from the sound source,
(ii) information regarding an acoustic signal bandwidth or a frequency characteristic,
(iii) information regarding reliability of a voice recognition result or a calculation time taken for voice recognition,
(iv) information regarding validity of an utterance as a command calculated based on the voice recognition result, or
(v) information regarding difficulty in interpretation of an input utterance obtained based on the voice recognition result; and
the estimation model is learned by using the label included in the learning data, the acoustic feature, the text feature, and said another feature.

20. The computer implemented method according to claim 17, wherein
the learning data includes the acoustic signal for learning, the label indicating whether or not the acoustic signal for learning has been uttered to the predetermined target, and a confidence level at the time of giving the label,
the processor further configured to execute operations comprising:
estimating the confidence level at the time of giving the label by using the post-synchronization feature; and
updating the parameter of the estimation model on the basis of the label, the estimated whether the acoustic signal has been uttered to the predetermined target, the confidence level included in the learning data, and the estimated confidence level.

21. The computer implemented method according to claim 17, wherein:
another feature includes at least one of:
(i) information regarding a position or direction of a sound source and a distance from the sound source,
(ii) information regarding an acoustic signal bandwidth or a frequency characteristic,
(iii) information regarding reliability of a voice recognition result or a calculation time taken for voice recognition,
(iv) information regarding validity of an utterance as a command calculated based on the voice recognition result, or
(v) information regarding difficulty in interpretation of an input utterance obtained based on the voice recognition result; and
the estimation model is learned by using the label included in the learning data, the acoustic feature, the text feature, and said another feature.
